(19) United States
(12) Patent Application Publication
(10) Pub. No.: US 2007/0070069 A1
(43) Pub. Date: Mar. 29, 2007

(54) System and method for enhanced situation awareness and visualization of environments

(76) Inventors: Supun Samarasekera, Princeton, NJ (US); Rakesh Kumar, West Windsor, NJ (US); Taragay Oskiper, East Windsor, NJ (US); Harpreet Sawhney, West Windsor, NJ (US); Manoj Aggarwal, Lawrenceville, NJ (US)

Correspondence Address: PATENT DOCKET ADMINISTRATOR;LOWENSTEIN SANDLER P.C., 65 LIVINGSTON AVENUE, ROSELAND, NJ, 07068, US

(21) Appl. No.: 11/527,987

(22) Filed: Sep. 26, 2006

Related U.S. Application Data
(60) Provisional application No. 60/720,553, filed on Sep. 26, 2005.

(51) Int. Cl. G06T 15/20

(52) U.S. Cl. 345/427

(57) ABSTRACT

The present invention provides a system and method for processing real-time rapid capture, annotation and creation of an annotated hyper-video map for environments. The method includes processing video, audio and GPS data to create the hyper-video map which is further enhanced with textual, audio and hyperlink annotations that will enable the user to see, hear, and operate in an environment with cognitive awareness. Thus, this annotated hyper-video map provides a seamlessly navigable, situational awareness and indexable high-fidelity immersive visualization of the environment.

### CROSS-REFERENCE TO RELATED APPLICATIONS

This application claims the benefit of U.S. Provisional Patent Application No. 60/720,553 filed Sep. 29, 2005, the entire disclosure of which is incorporated herein by reference.

### FIELD OF THE INVENTION

The invention relates generally to situational awareness and visualization systems. More specifically, the invention relates to a system and method for providing enhanced situation awareness and immersive visualization of environments.

### BACKGROUND OF THE INVENTION

In order to be prepared to operate in remote, unknown environments effectively, it is highly beneficial for a user to be provided with a visual and sensory environment that can virtually immerse them in it at a remote location. The immersion should enable them to get a near physical feel for the layout, structure and threat-level of buildings and other structures. Furthermore, the virtual immersion should also bring to them the level of crowds, typical patterns of activity and typical sounds in different parts of the environment as they virtually drive through an extended urban environment. Such an environment provides a rich context in which to do Route Visualization for many different applications. Some key application areas for such a technology includes online active navigation tool for driving directions with intuitive feedback on geo-indexed routes on a map or on video, online situation awareness of large areas using multiple sensors for security purposes, offline authoring of direction and route planning, offline training of military and other personnel on a unknown environment and its cultural significance.

Furthermore, there are no current state-of-the-art tools that exist for creation of a geo-specific navigable video map for data that has been continuously captured. Tools developed in the 90's such as QuickTimeVR work with highly constrained means of capturing image snapshots at key, pre-defined and calibrated locations in a 2D environment. The QTVR browser then just steps through a series of 360 deg snapshots as the user moves along on a 2D map.

At present, the state-of-the-art situational awareness and visualization systems are based primarily on creating synthetic environments that mimic a real environment. This is typically achieved by creating geo-typical or geo-specific models of the environment. The user can then navigate through the environment using interactive 3D navigation interfaces. There are some major limitations with the 3D approach. First, it is generally very hard to create high-fidelity geo-specific models of urban sites that capture all the details that a user is likely to encounter at ground level. Second, 3D models are typically static and do not allow a user to get a sense of the dynamic action such as movements of people, vehicles and other events in the real environment. Third, it is extremely hard to update static 3D models given that urban sites undergo continuous changes both in the fixed infrastructure as well as in the dynamic entities. Fourth, it is extremely hard to capture the physical and cultural ambience of an environment even with a geo-specific model since the ambience changes over different times of day and over longer periods of time.

Thus, there is a need to provide a novel platform for enhanced situational awareness of a real-time remote natural environment, preferably without the need for creating a 3D model of the environment.

### SUMMARY OF THE INVENTION

The present invention provides a system and method for providing an immersive visualization of an environment. The method comprises receiving in real-time a continuous plurality of captured video streams of the environment via a video camera mounted on a moving platform, synchronizing a captured audio with said video streams/frames and associating GPS data with said captured video streams to provide metadata of the environment; wherein the metadata comprises a map with vehicle location and orientation of each video stream. The method further comprises automatically processing the video streams with said associated GPS data to create an-annotated hypervideo map, wherein the map provides a seamlessly navigable and indexable high-fidelity visualization of the environment.

### BRIEF DESCRIPTION OF THE DRAWINGS

FIG. 1 is a block diagram illustrating a system for enhanced situation awareness and visualization for remote environments.

FIG. 2 illustrates an exemplary image of an annotated hyper-video map depicting the situational awareness and the visualization system of the present invention.

FIG. 3 illustrates the capture device of the system in FIG. 1.

FIG. 4 illustrates an exemplary image of the annotated hyper-video map depicting the visual situational awareness and geo-spatial information aspects of the present invention.

FIG. 5 illustrates exemplary images for obtaining 3D measurements according to a preferred embodiment of the present invention.

FIG. 6 illustrates exemplary image of object detection and localization according to a preferred embodiment of the present invention.

FIG. 7 illustrates exemplary annotated images according to a preferred embodiment of the present invention.

### DETAILED DESCRIPTION OF THE INVENTION

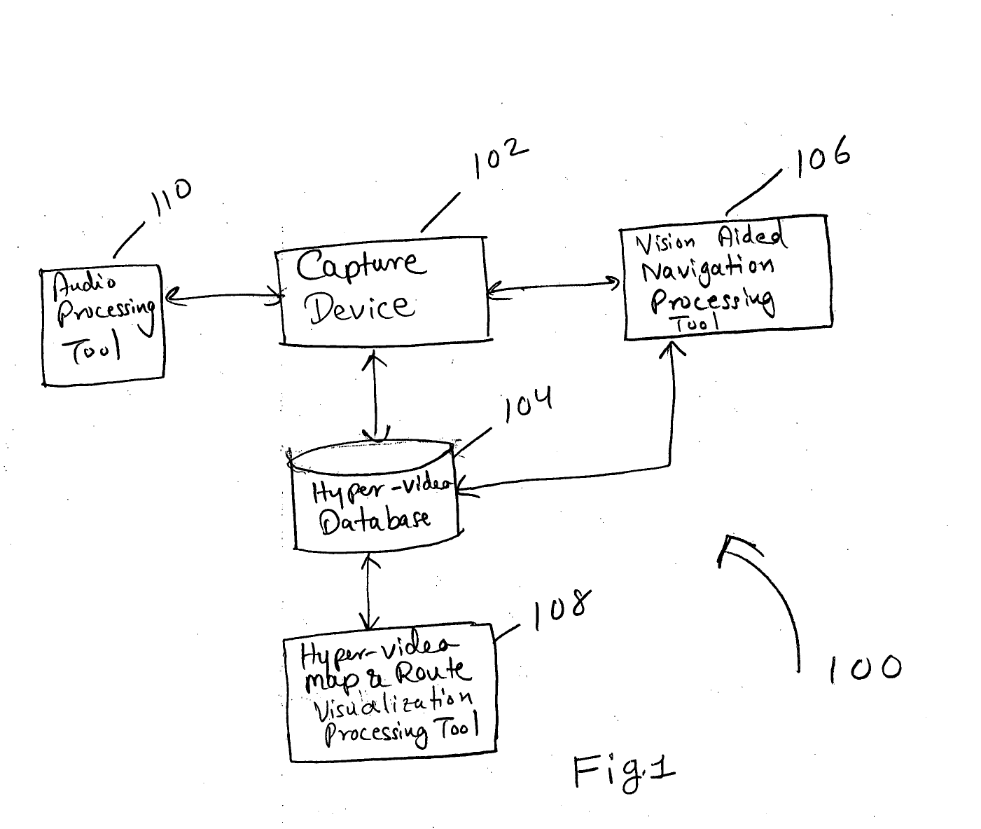

Referring to FIG. 1, there is shown a block diagram illustrating a system for enhanced situation awareness and visualization for remote environments. The system 100 comprises of a capture device 102 preferably installed on a moving platform. The capture device comprises of a camera, audio and a GPS antenna receiving video image data, audio data and GPS data of the remote environment simultaneously while the platform is in motion. The capture device captures a remote environment with a real-time high resolution camera and directional surround sound as will be described in greater detail below. The data received from the capture device 102 is stored in a hyper-video database 104. The hyper-video database 104 is built on top of a geo-spatial database (having geo-spatial information) with fast spatio-temporal indexing. Video, metadata and derived information is stored in the hyper-video database 104 with common indexable timestamps for comprehensive synchronization. The system further comprises of a vision aided navigation processing tool 106 which retrieves the image, and the GPS data from the database 104 and further combines to compute a metadata comprising of a 3D visualization, i.e. 3D motion poses or estimates, of the location and orientation of the moving platform. These 3D motion poses are inserted back into the hyper-video database 104. This specifically builds up the geo-spatial correlations and indeces in a table. Also, included in the system is a hyper-video map and route visualization processing tool 108 which process the video and the associated GPS and 3D motion estimates with a street map of the environment to generate a hyper-video map. The process allows the system ingest and correlate standard geo-spatial map to produce the hyper-video map. Optionally, if such map is not available, a semantic map may preferably be extracted based on the video and poses that are derived. The hyper-video map and route visualization processing tool 108 further provides a GUI interface allowing a user to experience environment through multiple trips merged into a single hyper-video database 104. Each trip is correlated in space and time through processes described above. Multiple trips can preferably be used to understand changes in the ecology at a specific location over different days/times. Thus, by integrating the multiplicity of these trips into the hyper-video map, it is able to present the user with navigation capability over a larger area or over time rapidly. The system 100 additionally comprises an audio processing tool 110 which retrieves audio data from the database 104 and provides audio noise reduction and 3D virtual audio rendering. The audio processing tool 100 also provides insertion of audio information for visualization. The detail functions of each of these devices are described in greater detail below.

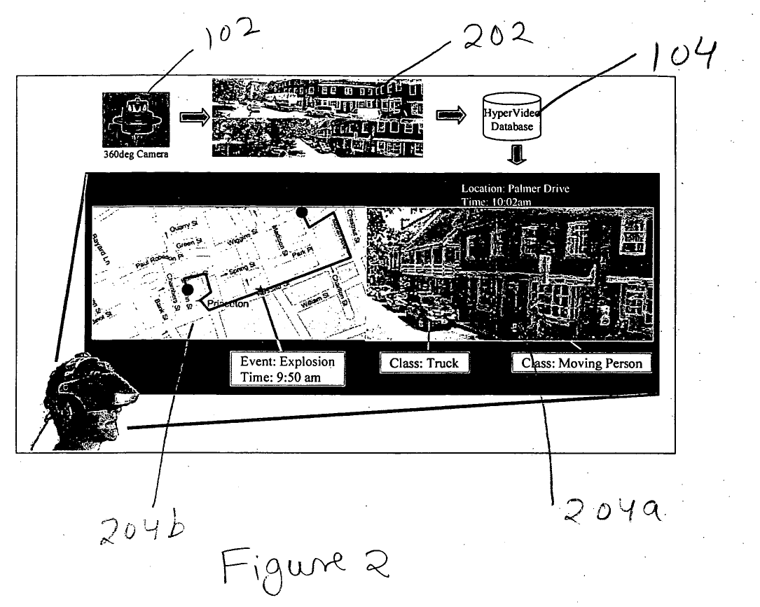

Referring to FIG. 2, there is shown an exemplary image of the annotated hyper-video map depicting the visual situational awareness and visualization system 100 of the present invention. As shown in FIG. 2 is a capture device 102 such as a camera, preferably a 360 deg. camera, taking an image of an exemplary street 202 in a remote urban environment. The image is stored in a hypervideo database 104 which is further processed to create an exemplary annotated hypervideo map 204 depicting the visual situational awareness 204a and geo-spatial information 204b of the street in a remote urban environment. The hypervideo map 204 as shown in FIG. 1 preferably provides a map-based spatial index into the video database 104 of a complex urban environment. The hypervideo map 204 is also annotated with spatial, contextual and object/scene specific information for geo-spatial and cultural awareness. The user sees the realism of the complex remote environment and also can access the hyper-video database from the visual/map representation.

Capture Device

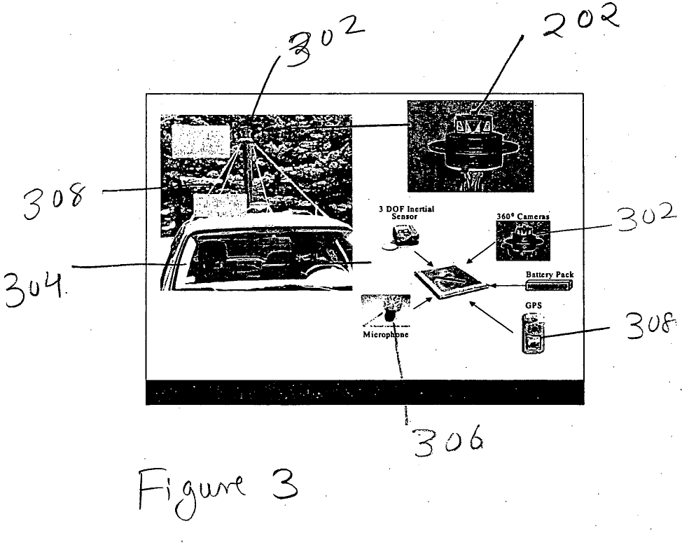

As shown in FIG. 3 is the capture device 102 comprising a camera 302 easily mounted on the moving platform 304 such as vehicle on road. The camera 302 is preferably a 360 degree camera capturing video data at any given location and time for the complete 360 degree viewpoints. Additionally, the camera 302 captures every part of the field-of-view at a high resolution and also has the capability of real-time capture and storage of the 360 deg. video stream. The capture device 102 also comprises of a directional audio 306 such as microphones. The audio 306 is preferably a spherical microphone array for 3D audio capture that is synchronized with video streams. Also part of the capture device 102 is a GPS antenna 308 along with the standard capture hardware and software (not shown) mounted on the vehicle 304. The GPS antenna 308 provides for capture of location and orientation data. The capture device will preferably be able to handle data and processing to complete coverage of a modest-size town or a small city.

The above-mentioned camera 202 is also general enough to handle not just 360 deg video but also numerous other camera configurations that can gather video centric information from moving platforms. For instance a single camera platform or a multiple stereo camera pairs can be integrated into the route visualizer as well. In addition to having video and audio other sensors can also be integrated into the system. For instance a lidar scanner (1D or 2D) can be integrated into the system to provide additional 3D mapping capabilities and better mensuration capabilities.

Optionally, an inertial measuring unit, i.e. IMU (not shown) providing inertial measurements of the location data of the moving platform 304 can also be mounted and integrated into the capture device 102. As known in the art the IMU provides altitude, location, and motion of the moving platform. Alternatively, sensor such as a 2D lidar scanner can also be preferably integrated into the capture device 102. The 2D lidar scanner can be utilized to obtain lidar data of the images. This can be used in conjunction with the video or independently to obtain consistent poses of the camera sensor 202 across time.

Although the moving platform 204 as shown in FIG. 2 is a vehicle on ground, it is to be noted that the moving platform can also preferably be a vehicle on air. Although, not shown, the camera device 102 mounted on the platform 202 may preferably be concealed and the microphones are preferably distributed around the platform 202. The data collection of video, audio and geo-spatial/GPS capture will be done in real-time at the speeds at which typical vehicles cruise through typical towns and cities. As mentioned above, video, audio and geo-spatial data collection can be done both from the ground and air. Note that the system 100 requires no user interaction during the time of data collection, however, the users may optionally choose to provide audio and/or textual annotations during data collection for locations of interest, highlighting people, vehicles and sites of operational importance, as well as creating “post-it” digital notes for later reference.

The captured video and audio data along with the associated geo-spatial/GPS data retrieved from the capture device 102 is stored in the database 104 which is further processed using the vision aided navigation processing tool 106 as described hereinbelow.

Vision Aided Navigation Processing Tool

A. Video Initial Navigation System (INS): Using standard video algorithms and software, one can automatically detect features in video frames and track the features over time to compute precisely the camera and platform motion. This information that is derived at the frame rate of videos can be combined with GPS information using known algorithms and/or software to precisely determine the location and orientation of the moving platform. This is especially useful in urban setting where urban may have no or at best spotty GPS coverage. Also, provided is a method to perform frame-accurate localization based on short-term and long-term landmark based matching. This will compensate for translational drift errors that can accumulate as will be described in greater detail below.

Preferably, the inertial measurements can be combined with the video and the associated GPS data to provide a precision localization of the moving platform. This capability will enable the system to register video frames with precise world coordinates. In addition, transfer of annotations between video frames and a database may preferably be enabled. Thus, the problem of precise localization of the capture videos with respect to the world coordinate system will be solved by preferably integrating GPS measurements with inertial localization based on 3D-motion from known video algorithms and software. Thus, this method provides a robust environment to operate the system when only some of the sensor information is used. For example you may not want to compute poses (images) based on video during the online process. Still the visual interaction and feedback can be provided based on just the GPS and initial measurement information. Similarly a user may enter areas of low GPS coverage in which instance the video INS can compensate for the missing location information.

As discussed above, a lidar scanner can alternatively be integrated as part of the capture device 102. The lidar frames can be registered to each other or to a accumulated reference point cloud to obtain relative poses between the frames. This can be further improved using landmark based registration of features that a temporally further apart. Bundle adjustment of multiple frames can also improve the pose estimates. The system can extract robust features from the video that act as a collection of landmarks to remember. These can be used to correlate when ever the same location is revisited either during the same trip or over multiple trips. This can be used to improve the pose information previously computed. These corrections can be further propagated across multiple frames of the video through a robust bundle adjustment step. The relative poses obtained can be combined with GPS and IMU data to obtain an absolute location of the sensor rig. In a preferred embodiment, both lidar and video can provide an improved estimation of the poses using both sensors simultaneously.

B. 3D Motion Computation and 3D Video Stabilization and Smoothing: 3D motion of the camera can be computed using the known technique disclosed by David Nister and James R. Bergen (hereinafter “Nister et al”), Real-time video-based pose and 3D estimation for ground vehicle applications, ARL CTAC Symposium, May 2003 and Bergen, J. R., Anandan, P., Hanna, K. J., Hingorani, R (hereinafter “Bergen et al”), Hierarchical Model-Based Motion Estimation, ECCV92(237-252) 3D pose estimates are computed for every frame in the video for this application. These estimates are essential for providing a high fidelity immersive experience. Images of the environment are detected and tracked over multiple frames to establish point correspondences over time. Subsequently, a 3D camera attitude and position estimation module employs algebraic 3D motion constraints between multiple frames to rapidly hypothesize and test numerous pose hypotheses. In order to achieve robust performance in real-time, the feature tracking and hypotheses generating and test steps are algorithmically and computationally highly optimized. A novel preemptive RANSAC (Random Sample Consensus) technique is implemented that can rapidly hypothesize pose estimates that compete in a preemptive scoring scheme that is designed to quickly find a motion hypothesis that enjoys a large support among all the feature correspondences, providing the required robustness against outliers in the data (e.g. independently moving objects in the scene). A real-time refinement step based on an optimal objective function is used to determine the optimal pose estimates from a small number of promising hypotheses. This technique is disclosed by combination of the above mentioned articles by Nister et al and by Bergen et al. with M. Fischler and R. Bolles, Random Sample Consensus: a Paradigm for Model Fiting with Application to Image Analysis and Automated Cartography, Commun. Assoc. Comp. Mach., 24:3810395, 1981.

Additionally, vehicle born video obtained from the camera rig can be unstable from the jitter, jerks and sudden jumps in the captured due to the physical motion of the vehicle. The computed 3D pose estimates will be used to smooth the 3D trajectory to remove high-frequency jitter, thus providing a video stabilization and smoothing technology to alleviate these effects. Based on the 3D pose the location (trajectory) of where the platform could be smoothed. Additionally a dominant plane seen in the video (such as the ground plane) can be used as a reference to stabilize the sequence. Based on the stabilization parameters derived a new video sequence can be synthesized that is very smooth. The video synthesis can use either a 3D or 2D image processing methods to derive new frames. The computed 3D poses will be provide a geo-spatial reference to where the moving platform was and the travel direction. These 3D poses will further stored in the hyper-video database 104.

Alternatively, a multi camera device may be employed to provide improved robustness in exploiting features across the scene, improved landmark matching of the features and improved precision over a wide field of view. This provides for very strong constraints in estimating the 3D motion of the sensor. In both the known standard monocular and stereo visual odometry algorithm, the best pose for that camera at the end of the preemptive RANSAC routine is passed to a pose refinement. This is generalized in the multi-camera system and the refinement is distributed across cameras in the following way as described herewith. For each camera, the best cumulative scoring hypothesis is refined not only on the camera from which it originated but also on all the cameras after it is transferred accordingly. Then, the cumulative scores of these refined hypotheses in each camera are computed and the best cumulative scoring refined hypothesis is determined. This pose is stored in the camera it originated (it is transferred if the best pose comes from a different camera than the original). This process is repeated for all the cameras in the system. At the end, each camera will have a refined pose obtained in this way. As a result, we take advantage of the fact that a given camera pose may be polished better in another camera and therefore have a better global score. As the very final step, the pose of the camera, which has the best cumulative score, is selected and applied to the whole system.

In a monocular multi-camera system, there may still be a scale ambiguity in the final pose of the camera rig. By recording GPS information with the video scale can be inferred for the system. Alternately we can introduce an addition camera to form a stereo pair to recover scale.

C: Landmark Matching: Even with the multi-camera system as described above, the aggregation of frame-by-frame estimates can eventually accumulate significant error. With dead reckoning alone, two sightings of the same location, may be mapped to different locations in a map. However, by recognizing landmarks corresponding to the common location and identifying that location as the same, an independent constraint on the global location of the landmark is obtained. This global constraint based optimization combined with locally estimated and constrained locations leads to a globally consistent location map as the same locale is visited repeatedly.

Thus, the approach will be able to locate a landmark purely by matching its associated multi-modal information with the landmark database constructed in a way to facilitate efficient search. This approach is full described by Y. Shan, B. Matei, H. S. Sawhney, R. Kumar, D. Huber, M Hebert, “Linear Model Hashing and Batch RANSAC for Rapid and Accurate Object Recognition ”, IEEE International Conference on Computer Vision and Pattern Recognition,2004. Landmarks are employed both for short range motion correction and long range localization. Short-range motion correction uses landmarks to establish feature correspondences over a longer time span and distance than what is done by the frame-to-frame motion estimation. With an increased baseline over a larger time gap, motion estimates are more accurate. Long-range landmark matching establishes correspondences between newly visible features at a given time instant and their previously stored appearance and 3D representations. This enables high accuracy absolute localization and avoids drift in frame-to-frame location estimates.

Moreover, vehicle position information provided by video INS and GPS may preferably be fused in an EKF (Extended Kalman Filter) framework together with measurements obtained through landmark matching to further improve the pose estimates. GPS acts as a mechanism of resetting drift errors accumulated in the pose estimation. In the absence of GPS (due to temporary drops) landmark-matching measurements will help reduce the accumulation of drift and correct the pose estimates.

Hyper-Video Map and Route Visualization Processing Tool

Since the goal is to enable the user to virtually “drive/walk” on city streets while taking arbitrary routes along roads, the stored video map cannot simply put the linearly captured video on a DVD. Thus, the hyper-video map and route visualization tool processes the video and the associated GPS and 3D motion estimates with a street map of the environment to generate a hyper-video map. Generally, the 3D pose computed as described above, provides a metadata of a route map comprising geo-spatial reference to where the moving platform was and the travel direction. This will provide the user the capability to mouse over the route map to spatially hyper-index into any part of the video instantly. Regions around each of these points will also be hyper indexed to provide rapid navigational links between different parts of the video. For example, when the user navigates to an intersection using the hyper-indexed visualization engine, he can pick a direction he wants to turn to. The corresponding hyper-link will index into the correct part of the video that contains that subset of the route selected. The detailed description of the processing and route visualization is described herein below.

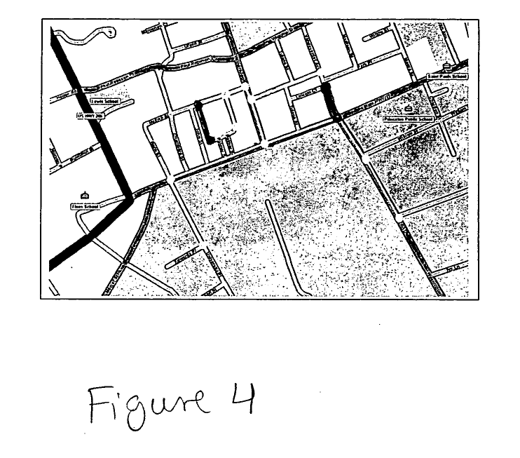

A. Spatially Indexable Hyper Video Map: The hyper-video and route visualization tool retrieves from the database, N video sequences, synchronized with time stamps, metadata comprising of map with vehicle location (UTM) and orientation for each video frame in the input sequences. The metadata is scanned to identify the places where the vehicle path intersects itself and generates a graph corresponding to the trajectory followed by the vehicle. Each node in the graph corresponds to a road segment and edges link nodes if the corresponding road segments intersect. For each node, a corresponding clip from the input video sequences are extracted, and a pointer is stored to the video clip in the node. Preferably, a map or overhead photo of the area may optionally be retrieved from the database, so the road structure covered by the vehicle can be overlaid on it for display and verification. This results in a spatially indexable video map that can be used in several ways. FIG. 4 shows an example of a generated indexable video map, highlighting the road segments for which video data exists in the database. By clicking on a road segment in the map, the corresponding video clip will be presented. If a trajectory is specified over the graph, the video sequence for each node is played sequentially. The trajectory can be specified by clicking on all the road segments on the map or alternatively be generated by a routing application after the user selects a start and an end point. Given a particular geo-spatial coordinate (UTM location), a video can be displayed of the road segment closest to that location. The indexing mechanism and computations are pre-computed and are integrated in to the database. However these mechanisms and functionality are directly tied in through the GUI to the users.

B. Route Visualization GUI: The GUI interface would be provided to each user to experience environment though multiple trips/missions merged into a single hyper-video database 104. The hyper-indexed visualization engine acts as a functional layer to the GUI front-end to rapidly extract information from the database that would then be rendered on the map. The user would be able to view the route as it evolves on a map and simultaneously view the video and audio as the user navigates through the route using the hyper-indexed visualization engine. Geo-coded information available in the database would be overlaid on the map and the video to provide intuitive training experience. Such information may include geo-coded textual information, vector graphics, 3D models or video/audio clips. The hyper-video and route visualization tool 108 integrates with the hyper-video database 104 that will bring in standardized geo-coded symbolic information into the browser. The user will be able to immerse into the environment by preferably wearing head mounted goggles and stereo headphones.

Audio Processing Tool

The sound captured by the audio 204 preferably comprising a spherical microphone array may be corrupted by the noise of the vehicle 202 upon which it is mounted. The noise of the vehicle is removed using adaptive noise cancellation (ANC), whereby a reference measurement of the noise alone is subtracted from each of the microphone signals. The noise reference is obtained either from a separate microphone nearer the vehicle, or from a beam pointed downwards towards the vehicle. In either case, frequency-domain least means squares (FDLMS) is the preferred ANC algorithm, with good performance and low computational complexity.

The goal of audio-based rendering is to capture a 3D audio scene in a way that allows later virtual rendering of the binaural sounds a user would hear for any arbitrary look direction. To accomplish this, a spherical microphone array is preferably utilized for sound capture, and solid cone beam forming convolved with head related transfer functions (HRTF) to render the binaural stereo.

Given a monaural sound source in free space, HRTF is the stereo transfer function from the source to an individual's two inner ears, taking into account diffraction and reflection of sound as it interacts with both the environment and the user's head and ears. Knowing the HRTF allows processing any monaural sound source into binaural stereo that simulates what a user would hear if a source were at a given direction and distance.

In a preferred embodiment, a 2.5 cm diameter spherical array with six microphones is used as an audio 204. During capture, the raw signals are recorded. During rendering, the 3D space is divided into eight fixed solid cones using frequency invariant beam forming based on the spherical harmonic basis functions. The microphone signals are then projected into each of the fixed cones. The output of each beam former is then convolved with an HRTF defined by the look direction and cone center, and the results summed over all cones.

In another embodiment of the present invention, an algorithm and software may preferably be provided by the audio processing tool 110 to develop an interface for inserting audio information into scene for visualization. For example inserting small audio snippet of someone talking about a threat in a language not familiar to the user, into a data collect done in a remote environment, may test the users ability comprehend some key phrases in the context of the situation for military training. As another example, audio commentary of a tourist destination will enhance a travelers experience and understanding of areas he is viewing at that time.

Furthermore, in another embodiment of the present invention, key feature points on each video frame will be tracked and 3D location of these points will be computed. The known standard algorithms and/or software as described by Hartley, Zisserman, “Multiple View Geometry in Computer Vision”: Cambridge University Press, 2000, provide means of making 3D measurements within the video map as the user navigates through the environment. This will require processing of video and GPS data to derive 3D motion and 3D coordinates to measure distances between locations in the environment. The user can manually identify points of interest on the video and obtain the 3D location of the point and the distance from the vehicle to that point. This requires the point to be identified in at least two spatially separated video frames. The separation of the frames will dictate the accuracy of the geo-location for a given point. This will provide a rapid tool for identifying a point across two frames. When the user selects a point of interest the system will draw the corresponding epipolar line on any other selected frame to enable the user to rapidly identify the corresponding point in that frame.

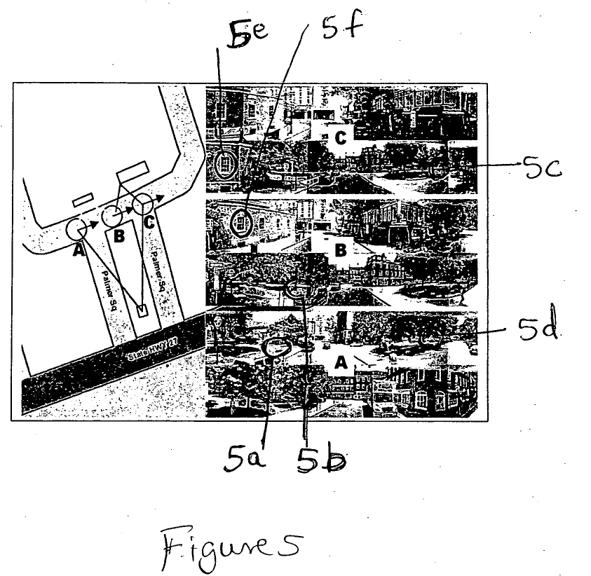

In order to estimate 3D structure along the road (store fronts, lamp posts, parked cars, etc.) or the 3D location of distant landmarks, it is necessary to track distinctive features across multiple frames in the input video sequence and triangulate the corresponding 3D location of the point in the scene. FIG. 5 illustrates this process. On the left, three successive positions A, B, C of the vehicle track are marked on a map. The corresponding 360 degrees panoramas for each of the three locations are shown on the right. These panoramas are constructed by stitching together images captured from eight cameras mounted as shown in FIG. 3. The top row shows data from the forward-looking cameras, the bottom row shows the data from the rear-looking cameras flipped left-right (simulate a rear-view mirror). In the initial version of the system, the user will select corresponding features in several frames. For example, in FIG. 5, there is shown a triangulation of 3D scene points where three objects in the scene were marked, each one in two frames: a bench on the left side of the road, circled as 5a and 5b, a statue on the road to the right, circled as 5c and 5d, and a window on the left, circled as 5e and 5f. An estimate of the camera position and orientation is available for each of the three locations (A, B and C) from visual odometry. Each image point corresponds to a ray in 3D, and given the location and orientation of the camera, that ray can be projected on the map (the lines on the left side of FIG. 5, drawn as the corresponding features in the images on the right). By intersecting the rays for the same feature, the location of the point in the scene can be estimated. Once the 3D location of the point in the world is known, a number of operations are possible such as the distance between two points in the scene can be estimated, distant landmarks that are visible from the current vehicle location can be placed in the map, etc.

Alternatively, user-selected features or points can be tracked automatically. In this case the user clicks on the point of interest in one image, and the system tracks the feature in consecutive frames. An adaptive template matching technique could be used to track the point. The adaptive version will help match across changes in viewpoint. For stable range estimates, it is important that the selected camera baseline (i.e. distance from A to B) be sufficiently large (the baseline should be at least 1/50 of the range).

Optionally, if stereo data or lidar data, is available the measurements made by using the 3D location information provided by the sensor can be directly be used with its pose to estimate location. Multiple frames can yet be used to improve the estimated results. Lidar provides accurate distance measure to points in the environment. These combined with the posses lets you build an accumulated point cloud in a single 3D coordinate system. These 3D measurements can be extracted by going back to these accumulated point-cloud.

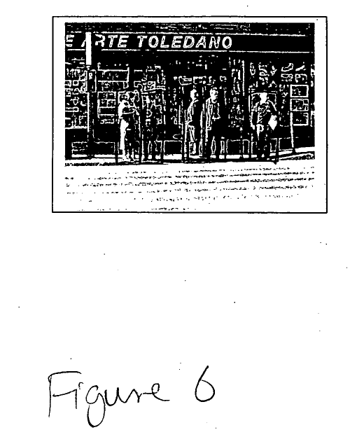

a preferred embodiment of the present invention, object recognition cores can preferably be integrated into the route visualization system to provide annotation of the hyper-video map with automatic detection and classification for common objects seen in the spatially indexed hyper-video map. A few key classes such as people, vehicles and buildings are identified and inserted into the system so the user can view these entities during visualization. This capability can further be extended to a wider array of classes and subclasses. The user will have the flexibility of viewing video annotated with these object labels. An example of automated people detection and localization is shown in FIG. 6. These objects will also be tracked across video frames to geo-locate them. The user will be able to query and view these objects on geo-specific annotated map or the video. When 3D information is available you will be able to build up object classed in 3D. Object classification can use salient 3D features instead in representing a fingerprint of the object. These can be used to build up a geo-located object database of the classes of interest. (Briefly explain about the geo-located object database)

One preferred approach to object detection and classification employs a comprehensive collection of shape, motion and appearance constraints. Algorithms developed to robustly detect independent object motions after computing the 3D motion of the camera are disclosed in Tao, H; Sawhney H. S.; Kumar, R; “Object Tracking with Bayesian Estimation of Dynamic Layer Representations”, IEEE Transactions on Pattern Analysis and Machine Intelligence, (24), No. 1, January 2002, pp. 75-89; Guo, Y., Hsu, Steve, Shan. Y, Sawhney H. S.; Kumar, R; Vehicle Fingerprinting for Reacquisition and Tracking in Videos, IEEE Proceedings of CVPR 2005 (II: 761-768) and Zhao, T., Nevatia, R., “Tracking Multiple Humans in Complex Situations,” IEEE Transactions on Pattern Analysis and Machine Intelligence, (26) No. 9, September 2004. In the embodiment of the present invention, the independent object motions will either violate the epipolar constraint that relates the motion of image features over two frames under rigid motion, or the independently moving objects will violate the structure-is-constant constraint over three or more frames. The first step is to recover the camera motion using the visual odometry as described above. Next, the image motion due to the camera rotation (which is independent of the 3D structure in front of the camera) is eliminated and the residual optical flow is computed. After recovering epipolar geometry using 3D camera motion estimation, and estimating parallax flow that is related to 3D shape, violations of the two constraints are detected and labeled as independent motions.

In addition to motion and shape constraints as discussed above, static image constraints such as 2D shape and appearance can preferably be employed as disclosed in Feng Han and Song-Chun Zhu, Bottom-up/Top-Down Image Parsing by Attribute Graph Grammar, ICCV 2005. Vol 2, 17-20 Oct. 2005 Page(s):1778-1785. This approach to object classification differs from previous approaches that use manual clustering of training data into multiple view and pose. In this approach, a Nested-Adaboost is proposed to automatically cluster the training samples into different view/poses, and thus train a multiple-view multiple-pose classifier without any manual labor. An example output for people and vehicle classification and localization is shown in FIG. 6. The computational framework unifies automatic categorization, through training of a classifier for each intra-class exemplar, and the training of a strong classifier combining the individual exemplar-based classifiers with a single objective function. The training and exemplar selection are preferably automated processes.

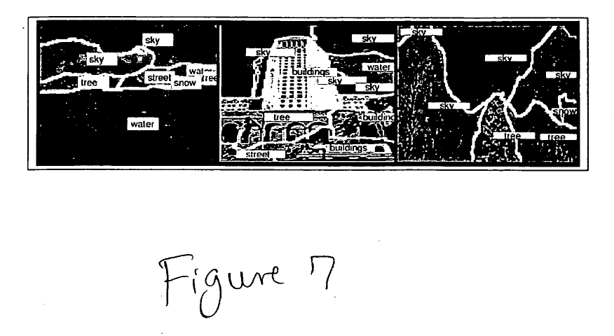

The moving platform will move through the environment, capturing image or video data, and additionally recording GPS or inertial sensor data. The system should then be able to suggest names or labels for objects automatically, indicating that some object or individual has been seen before, or suggesting annotations. This functionality requires building of models from all the annotations produced in the journey of the environment. Some models will link image structures with spatial annotations (e.g., GPS or INS); such models allow the identification of fixed landmarks. Other models will link image structures with transcribed speech annotations; such models make it possible to recognize these structures in new images. See FIG. 7 displaying images annotated automatically using the EM method. EM stands for Expectation Maximization. This is a standard technique that is used by experts in the image-processing and statistical fields of use. The annotation process is learned from a large pool of images, which are annotated with individual words, not spatially localized within the image, i.e. there are words next to, but not on, the training images. The user can pick a few example frames of objects that are of interest. The system can derive specific properties related to the picked example and use that to search for other instances of similar occurance. This can be used to label a whole sequence based on users feedback on a few short clips.

In order to link image structures to annotations, it is critical to determine which image structure should be linked to which annotation. In particular, if one has a working model of each object, then one can determine which image structure is linked to which annotation; similarly, if one knows which image structure is linked to which annotation, one can build an improved working model of each object. This process is relatively simply formalized using the EM algorithm described above.

In a further embodiment of the present invention, an algorithm and software is provided for storyboarding and annotation of video information collected from the environment. The storyboard provides a quick summarization of the events/trip laid out on the map that quickly and visually describes the whole trip in a single picture. The storyboard will be registered with respect to a map of the environment. Furthermore, any annotations stored in a database for buildings and other landmarks will be inherited by the storyboard. The user will also be able to create hot-spots of video and other events for others to view and interact with. For example, a marine patrol will preferably move over a wide area during the course of its mission. It is useful to characterize such a mission through some key locations or times of interest. User interface will present this information as a comprehensive storyboard overlaid on a map. Such a storyboard board provides a convenient summary of the mission and acts as a spatio-temportal menu into the mission. Spatio-Temporal is information that correlate items to spatial (location/geo-location) and temporal (time of occurance in a single unified context).

In a preferred embodiment, comparison of routes is a valuable function provided to the user. Two or more routes can be simultaneously displayed on the map for comparison. User will be able to set deviations of a path with respect to a reference route and have it be highlighted on the map. As the user moves cursor over the routes co-located video feeds will be displayed for comparison. Additionally the video can be pre-processed to identify gross changes to the environment and these can be highlighted in the video and the map. This can be a great asset in improved explosive device detection where changes to the terrain or newly parked vehicles can be detected and highlighted for threat assessment.

In a preferred embodiment, structure of the environment can be extracted and processed to build 3D models or facades along the route. In one aspect, with the monocular video, structure of the environment from motion can be computed to get information on the 3D. In another aspect, with the stereo cameras, the computed stereo depth can be used to estimate 3D structure. In an even further aspect with lidar images, 3D structure can be obtained from the accumulated point clouds. This can be incorporated into the route visualization to provide 3D rendering of the route and objects of interest.

In an additionally preferred embodiment of the present invention, the system will provide a novel way of storing, indexing and browsing video and map data and this will require the development of novel playback tools that are characteristically different from the traditional linear / non-linear playback of video data or navigation of 3D models. The playback took is simply able to take a storage device, for example, a DVD and allow the user simplified navigations through the environment. In addition to the play/indexing modes described in the spatially indexable videomap creation section described above, the video could contain embedded hyperlinks added in the map creation stage. The user can click on these links to change the vehicle trajectory (e.g. take a turn in an intersection). A natural extension of the playback tool is to add an orientation sensor on the helmet with the heads-up display through which the user sees the video. By monitoring the head orientation, the corresponding field of view (out of the 360 degrees) can be rendered, giving the user a more natural “look around” capability.

In an even further embodiment of the present invention, the system 100 as defined above can preferably be provided in live real-time use, i.e. live operational environment. In a live system on-line computation of the pose (location and view) information can be used to map out ones route on a map and on the live video available. In the live environment, the user will be able to overlay geo-coded information such as landmarks, road signs and audio commentary on the video and also provide navigation support at location where GPS coverage is not available or is spotty. For example if you enter into a tunnel, underpass or areas of high tree coverage the system can still provide accurate location information for navigation. Also, in a live environment, for example, in a military application, the user will be informed of potential threats based on online geo-coded information received and based on object classification/recognition components.

The live system can also be desirably extended to provide a distributed situation awareness system. The live system will provide a shared map and video based storyboarding of multiple live of the sensor systems are moving in the same environment, even though they be distributed over an extended area. Each moving platform embedded with a sensor rig such as the camera will act as an agent in the distributed environment. Route/location information from each platform along with relevant video clips will be transmitted to a central location or to each other, preferably via wireless channels. The route visualization GUI will provide a storyboard across all the sensor rigs and allow interactive user to hyper-index into any location of interest and get further drill down information. This will extend to providing a remote interface such that the information can be stored into a server that is accessed through a remote interface by another user. This also enables rapid updating of the information as additional embedded platforms are processes. This sets up a collaborative information-sharing network across multiple user/platforms active at the same time. The information each unit has is shared with others through a centralized server or through a network of local servers embedded with each unit. This allows the each unit to be aware of where the other units are and to benefit from the imagery seen by the other users.

Although various embodiments that incorporate the teachings of the present invention have been shown and described in detail herein, those skilled in the art can readily devise many other varied embodiments that still incorporate these teachings without departing from the spirit and the scope of the invention.

1. A method for providing an immersive visualization of an environment, the method comprising:
providing a map of the environment;
receiving a plurality of captured video streams of the environment via a video camera mounted on a moving platform;
associating navigation data with said captured video streams; said navigation data includes location and orientation data of the moving platform for each said captured video stream; and
retrieving the associated navigation data with said video stream to compute a metadata, wherein said metadata comprise 3D visualization of the location and orientation of the moving platform for each of the captured video stream; and
automatically processing said video streams with said associated navigation data and the 3D visualization with the map to create an-hypervideo map; wherein said hyper-video map provides a navigable and indexable high-fidelity visualization of the environment.

2. The method of claim 1 further comprising:
receiving audio data of the environment and the moving platform;
filtering the audio data of the moving platform; and
synchronizing the filtered audio data with said video streams.

3. The method of claim 1 wherein said navigation data comprises a global positioning satellite data of the moving platform for each of the captured video frame.

4. The method of claim 1 wherein said navigation data comprises an inertial measurement data of an altitude, location, and motion of the moving platform for each of the captured video frame.

5. The method of claim 1 wherein said metadata of 3D visualization is computed by detecting and tracking the multiple video streams to establish point correspondences over time and employing 3D motion constraints between the multiple video streams to hypothesize and test numerous pose hypotheses to produce 3D motion poses of the moving platform.

6. The method of claim 1 wherein said processing comprising:
scanning the metadata to generate a graph having nodes corresponding to a trajectory followed by the moving platform;
extracting from the video stream a corresponding video clip for each said node and storing a pointer to the video clip in the node; and
generating a hyper-video map displaying a road structure of the map of each video frame with highlighted road segments corresponding to the stored pointer for each video clip in the node.

7. The method of claim 1 further comprising recognizing landmarks in said video streams based on the landmark database to identify the location of the moving platform.

8. The method of claim 1 further comprising:
compressing the video data and storing in a format to enable seamless playback of the video frames.

9. The method of claim 1 further comprising:
identifying sites within the video streams and processing said metadata to measure distances between sites in the environment.

10. The method of claim 1 further comprising:
tracking and classifying objects within the video streams; and
providing annotation of the hyper-video map displaying said objects.

11. The method of claim 1 further comprising:
storyboarding of the captured video streams of the environment, said storyboarding comprising a virtual summarization of a route laid out on the annotated hyper-video map

12. The method of claim 1 further comprising:
providing at least two routes displayed on the annotated hyper-video map; and
comparing the at least two routes to identify any changes in the environment.

13. The method of claim 11 further comprising:
highlighting said changes in the video stream and the hyper-video map.

14. The method of claim 1 further comprising:
extracting a structure of the environment from the video streams; said structure comprising route and objects; and
processing said extracted structure to render a 3D image of the structure of the environment.

15. A method for providing a real-time immersive visualization of an environment, the method comprising:
providing a map of the environment
receiving in real-time a continuous plurality of captured video streams of the environment via a video camera mounted on a moving platform;
associating navigation data with said captured video streams; said navigation data includes location and orientation data of the moving platform for each said captured video stream; and
retrieving the associated navigation data with said video stream to compute a metadata, wherein said metadata comprise 3D visualization of the location and orientation of the moving platform for each of the captured video stream; and
automatically processing said video streams with said associated navigation data and the 3D visualization with the map to create an-hypervideo map; wherein said hyper-video map provides a navigable and indexable high-fidelity visualization of the environment.

16. The method of claim 15 further comprising:
receiving in real time a continuous audio data of the environment and the moving platform;
filtering the audio data of the moving platform; and
synchronizing the filtered audio data with said video streams.

17. The method of claim 15 wherein said navigation data comprises a global positioning satellite data of the moving platform for each of the captured video frame.

18. The method of claim 15 wherein said navigation data comprises an inertial measurement data of an altitude, location, and motion of the moving platform for each of the captured video frame.

19. The method of claim 15 wherein said metadata of 3D visualization is computed by detecting and tracking the multiple video streams to establish point correspondences over time and employing 3D motion constraints between the multiple video streams to hypothesize and test numerous pose hypotheses to produce 3D motion poses of the moving platform.

20. The method of claim 15 wherein said processing comprising:
scanning the metadata to generate a graph having nodes corresponding to a trajectory followed by the moving platform;
extracting from the video stream a corresponding video clip for each said node and storing a pointer to the video clip in the node; and
generating a hyper-video map displaying a road structure of the of each video frame with highlighted road segments corresponding to the stored pointer for each video clip in the node.

21. The method of claim 15 further comprising recognizing landmarks in said video streams based on the landmark database to identify the location of the moving platform.

22. The method of claim 15 further comprising:
compressing the video data and storing in a format to enable seamless playback of the video frames.

23. The method of claim 15 further comprising:
identifying sites within the video streams and processing said metadata to measure distances between sites in the environment.

24. The method of claim 15 further comprising:
tracking and classifying objects within the video streams; and
providing annotation of the hyper-video map displaying said objects.

25. The method of claim 15 further comprising:
storyboarding of the captured video streams of the environment, said storyboarding comprising a virtual summarization of a route laid out on the annotated hyper-video map

26. The method of claim 15 further comprising:
providing at least two routes displayed on the annotated hyper-video map; and
comparing the at least two routes to identify any changes in the environment.

27. The method of claim 26 further comprising:
highlighting said changes in the video stream and the hyper-video map.

28. The method of claim 15 further comprising:
extracting a structure of the environment from the video streams; said structure comprising route and objects; and
processing said extracted structure to render a 3D image of the structure of the environment.

29. A system for providing an immersive visualization of an environment, the system comprising:
a capture device comprising at least one video sensor mounted in a moving platform to capture a plurality of video streams of the environment and a navigation unit mounted on the moving platform to provide location and orientation data of the environment for each said captured video stream;
a hyper-video database linked to the capture device for storing the captured video stream and the navigation data; said database comprises a map of the environment;
a vision aided navigation processing tool coupled to the capture device and the hyper-video database for retrieving the combined video stream and the navigation data to compute a metadata, said metadata comprises a 3D visualization of the location and orientation of the moving platform for each said captured video stream, said 3D visualization is stored in the hyper-video database; and
a hyper-video map and route visualization processing tool coupled to the hyper-video database for automatically processing the video stream, the metadata and the 3D visualization with the map of the environment to generate a hyper-video map of the environment.

30. The system of claim 29 wherein said video streams of the environment are captured in real-time.

31. The system of claim 29 wherein said hyper-video map and route visualization processing tool provides to a user a graphical user interface of the hyper-video map of the environment.

32. The system of claim 29 wherein said capture device further comprises an audio sensor for capturing an audio data of the environment and the moving platform.

33. The system of claim 32 wherein said audio data is captured in real time.

34. The system of claim 29 further comprising an audio processing tool for filtering the audio data of the moving platform and reducing the noise in the filtered audio data.

35. The system of claim 33 wherein said audio processing tool provides a 3D virtual audio rendering of the audio data.

36. The system of claim 33 wherein said audio processing tool provides for an interface for interfacing audio information into a video stream for visualization.

37. The system of claim 33 wherein said video sensor comprises a 360 degrees video camera for capturing video data of the environment at any given location and time for a complete 360 degree viewpoints.

38. The system of claim 33 wherein said video sensor comprises a lidar scanner for capturing the image to provide an absolute position of the moving platform.

39. The system of claim 33 wherein said navigation unit comprises a GPS antenna for providing a satellite global positioning of the moving platform for each of the captured video frame.

40. The system of claim 33 wherein said navigation unit comprises an inertial measuring unit for providing an altitude, location, and motion of the moving platform for each of the captured video frame.
